(19) United States
(12) Patent Application Publication
(10) Pub. No.: US 2005/0235644 A1
(43) Pub. Date: Oct. 27, 2005

(54) Turbo-charged diesel engine with a "long route" exhaust-gas recirculation system

(75) Inventors: Marco Tonetti, Orbassano (IT); Dario Ivaldi, Orbassano (IT)

Correspondence Address: SUGHRUE MION, PLLC, 2100 PENNSYLVANIA AVENUE, N.W., SUITE 800, WASHINGTON, DC, 20037, US

(73) Assignee: C.R.F. SOCIETA CONSORTILE PER AZIONI

(21) Appl. No.: 11/020,202

(22) Filed: Dec. 27, 2004

(30) Foreign Application Priority Data
Apr. 21, 2004 (EP) 04425279.96

(51) Int. Cl. F01N 5/04; F02B 33/44

(52) U.S. Cl. 60/605.2; 60/280

(57) ABSTRACT

A turbo-charged diesel engine is provided with a “long route” exhaust-gas recirculation pipe, which branches off from a main exhaust pipe, downstream of the turbine of the turbosupercharger assembly, and converges in a main intake pipe of the engine, upstream of the compressor of the turbosupercharger assembly. In combination with said long-route recirculation pipe, there can be provided a further short-route recirculation pipe, which branches off from the main exhaust pipe upstream of the turbine and converges in the main intake pipe downstream of the compressor; or else, alternatively, there can be envisaged a system of programmed variable actuation of the engine valves to provide a simultaneous temporary opening of the intake valve and of the exhaust valve of each cylinder of the engine in order to obtain an exhaust-gas recirculation directly inside the engine.

### SUMMARY OF THE INVENTION

The present invention relates to turbo-charged diesel engines, of the type comprising:
at least one cylinder with at least one intake valve and at least one exhaust valve, which control, respectively, an intake pipe and an exhaust pipe;
a compressor set in a main air-intake pipe, connected to the aforesaid intake pipe of the cylinder;
a turbine for driving the aforesaid compressor, set in a main exhaust pipe, connected to the aforesaid exhaust pipe of the cylinder;
a device for treatment of exhaust gases, which is set in the main exhaust pipe, downstream of the turbine, and comprises catalytic-converter means and particulate-filtering means (which may be integrated in a single component that carries out both of the functions, or else may be constituted by two different components, without excluding the possibility of there being also present other components such as, for example, NOx traps; and
an exhaust-gas recirculation pipe, controlled by a respective exhaust-gas recirculation valve, for feeding at least part of the exhaust gases that flow in the main exhaust pipe back into the main intake pipe.

Conventional engines of the type indicated above typically comprise a number of cylinders and one or more turbosuperchargers, possibly integrated with an electric compressor. In said engines, typically used in motor vehicles, the exhaust-gas recirculation (EGR) pipe branches off from the main exhaust pipe, upstream of the turbine, and converges in the main intake pipe downstream of the compressor. Said known system is schematically illustrated in FIG. 1 of the annexed plate of drawings. In said figure, the reference number 1 designates as a whole a diesel-engine block with four cylinders 2, each provided with two intake pipes 3, 4 controlled by respective intake valves (not illustrated), and forming part of an intake manifold 5, which receives air through a main intake pipe 6. Arranged in series in the main intake pipe 6 are: an air filter 7; a flowmeter 8; a compressor 9; a cooling device or intercooler 10; and a throttle valve 11. Associated to each cylinder 2 of the engine 1 is moreover an exhaust pipe 12, controlled by a respective exhaust valve (not illustrated), forming part of an exhaust manifold 13 connected to a main exhaust pipe 14. Arranged in series in the main exhaust pipe 14 are a turbine 15, which drives the compressor 9 via a transmission shaft 16, and a device 17 for treatment of the exhaust gases, which comprises, set close to one another, a catalytic converter 17a and a filter for particulate 17b. Once again in the case of the known arrangement illustrated in FIG. 2, there is further provided an exhaust-gas recirculation pipe 18, which branches off from the exhaust pipe 14, upstream of the turbine 15, and converges into the main intake pipe 6, downstream of the compressor 9 and the intercooler 10. In a position corresponding to said confluence, there is provided a valve 19 for regulation of the gas flow through the recirculation pipe 18. Furthermore, in the example illustrated, the EGR pipe has an intermediate part, which branches into two pipes 18a and 18b parallel to one another, the pipe 18b traversing an intercooler 20. At the point in which the EGR pipe branches into the two parallel pipes 18a, 18b, there is provided a valve 21, which regulates the gas flow through each of the two parallel pipes 18a, 18b to enable variation of the degree of cooling of the exhaust gases.

The exhaust-gas recirculation system made in the known way described above presents some drawbacks. In the first place, the exhaust gases that are made to recirculate give rise to phenomena of dirtying of the valves, of the engine pipes and of the intercooler of the EGR system. In the second place, the mixing between the recirculated gas and the air taken in is not always optimal, so that there occurs a lack of uniformity of combustion in the various cylinders of the engine. Another drawback lies in the fact that the exhaust gases that are recirculated have a temperature that is still high, which gives rise to a high temperature of the gas/air mixture at input to the engine, with consequent production of noxious emissions and particulate. Finally, the turbine is not exploited in the most efficient way, given that not all the exhaust-gas flow passes through it.

With a view to overcoming the aforesaid drawbacks, the subject of the present invention is a turbo-charged diesel engine presenting all the characteristics that have been indicated at the beginning of the present description and further characterized in that the aforesaid exhaust-gas recirculation pipe branches off from the main exhaust pipe at a point downstream of the turbine and downstream of the exhaust-gas treatment device, and converges in the main intake pipe at a point upstream of the compressor. Consequently, the system according to the invention is of the “long route” type, where the recirculated gases follow a relatively long path as compared to that of the known system of FIG. 1, starting from a point downstream of the treatment device 17.

Thanks to the aforesaid characteristics, the engine according to the invention presents a series of advantages. In the first place, the recirculated gases are “clean”, in so far as they have already traversed the treatment device comprising the catalytic converter and the particulate filter. There are thus eliminated or in any case greatly reduced the phenomena of dirtying of the valves and of the engine pipes. A further advantage deriving from the invention is that of guaranteeing an excellent mixing between the recirculated gases and the fresh air, with consequent uniformity of combustion between the various cylinders. Furthermore, since the recirculated gases are taken in downstream of the turbine and downstream of the exhaust-gas treatment device, their temperature is relatively low, with the consequence that also the mixture of the recirculated gases with the air at input to the engine is at a relatively low temperature which enables reduction of emissions (particulate and NOx). Finally, thanks to the characteristics of the invention, the turbine is traversed by the entire flow of exhaust gases, which enables control of the compressor with maximum efficiency.

In a preferred embodiment, set in the exhaust-gas recirculation pipe is a gas-cooling device.

Furthermore, for the purpose of forcing the passage of large amounts of gas through the recirculation pipe, there can be provided a throttle actuator (or a device with an equivalent function) so as to increase the pressure jump on the exhaust-gas recirculation pipe. Said throttle device may be indifferently provided in the main intake pipe, upstream of the confluence with the exhaust-gas recirculation pipe, or in the main exhaust pipe, downstream of the point from which the exhaust-gas recirculation pipe branches off.

In the system according to the invention, the mixture of recirculated exhaust gases and air drawn in is then compressed by the compressor and cooled by the intercooler (air-air or air-water exchanger), which is provided in the intake pipe downstream of the compressor.

The valve for regulation of the flow of the recirculation gases may be of any known type and may be provided for example at the confluence of the recirculation pipe into the intake pipe.

As has already been said, the main advantage of the system according to the invention lies in the fact that the recirculated gases are “clean”, i.e., substantially without unburnt hydrocarbons and particulate matter.

A possible disadvantage of the system according to the invention, as defined above, could lie in a relatively slow response of the system, with possible problems of control in the transient regimes of the engine. A further possible drawback could lie in the fact that the mixture of the recirculated gases with the air at input to the engine is always at a relatively low temperature, with a consequent increase in the CO and HC emissions during cold starting of the engine. In order to eliminate also these possible disadvantages, in a preferred embodiment of the invention, in addition to the recirculation system described above, there is also envisaged an exhaust-gas recirculation system of a traditional “short route” type with a recirculation pipe of the type illustrated in FIG. 1, which branches off from the exhaust pipe upstream of the turbine and converges in the intake pipe downstream of the compressor. In this way, the engine exploits simultaneously both a recirculation system according to the invention, i.e., of the long-route type, and a recirculation system of the conventional short-route or “hot-gas” type.

Alternatively, again in combination with the long-route recirculation system according to the invention, the engine may be provided with an “internal” EGR system, according to the teachings of the preceding European patent application EP 1 273 770 A2, in the name of the present applicant. In this document, there is illustrated an engine provided with a system for variable actuation of the engine valves (which, in the framework of the present invention can be applied only to the intake valves or else both to the intake valves and to the exhaust valves). In said known system, which is applicable also to the engine according to the invention, the engine valves are controlled by the respective cams of the engine camshaft via the interposition of a chamber of fluid under pressure, which can be discharged by means of a solenoid valve controlled by an electronic control unit. When the pressurized chamber is discharged, the respective valve returns rapidly into its closing condition, even in the case where the control cam would tend to maintain it open. By exploiting said arrangement, it is thus possible to vary as required the times of opening and closing of the engine valves, according to any desired law. In particular, the European patent application mentioned above envisages the possibility of programming the electronic control means of the system so as to maintain the intake valves and the exhaust valves simultaneously open in some phases of the operating cycle of the engine to obtain an internal recirculation of the exhaust gases. According to said proposal, during the normal exhaust stroke of a cylinder of the engine, part of the exhaust gases returns into the intake pipe, instead of flowing into the exhaust pipe and is then re-introduced into the combustion chamber in the subsequent induction stroke. Furthermore, part of the exhaust gases that in the exhaust stroke normally enters the exhaust pipe of the cylinder, also returns into the combustion chamber during the induction stroke, again on account of the simultaneous opening of the intake and exhaust valves. Consequently, the two amounts of gas mentioned above return into the combustion chamber, to undergo a further combustion in the subsequent cycle.

As already indicated, also falling within the framework of the present invention is an engine which, in combination with a long-route EGR system of the type described above, will envisage also an “internal” EGR system of the type forming the subject of the document EP 1 273 770 A2. In this way, all the advantages of the long-route system are achieved, eliminating the drawbacks thereof.

### BRIEF DESCRIPTION OF THE DRAWINGS

The invention will now be described with reference to the annexed drawings, which are provided purely by way of non-limiting example, and in which:

FIG. 1, which has already been described, relates to a conventional engine according to the known art; whilst

FIG. 2 illustrates a preferred embodiment of the engine according to the invention.

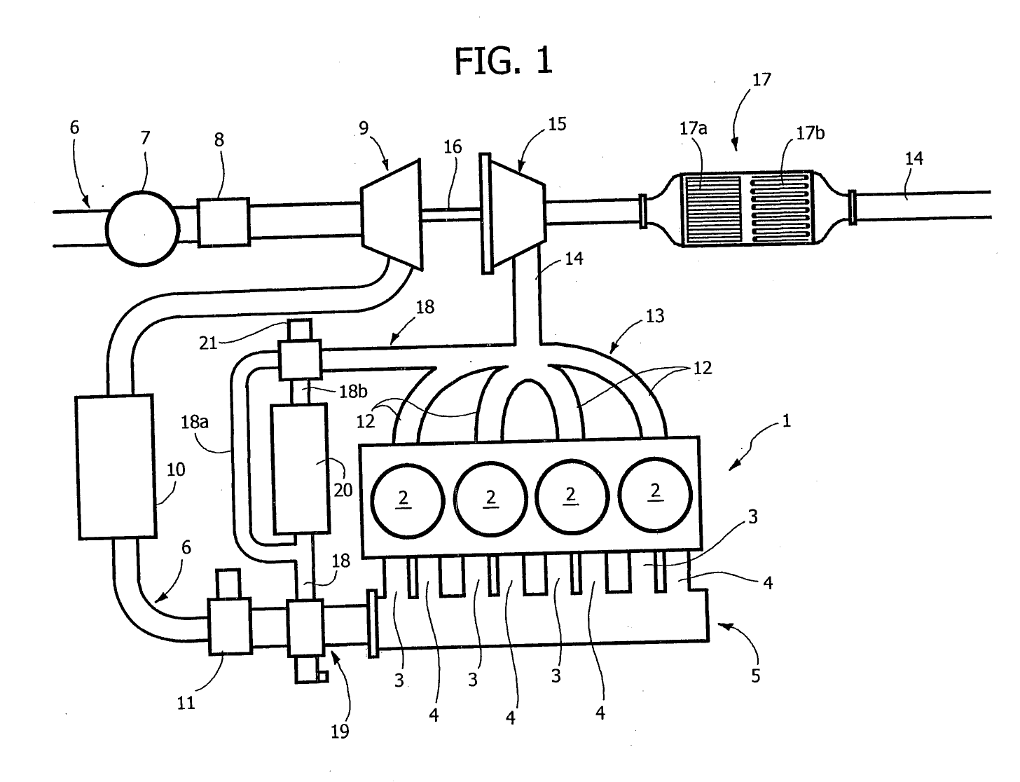

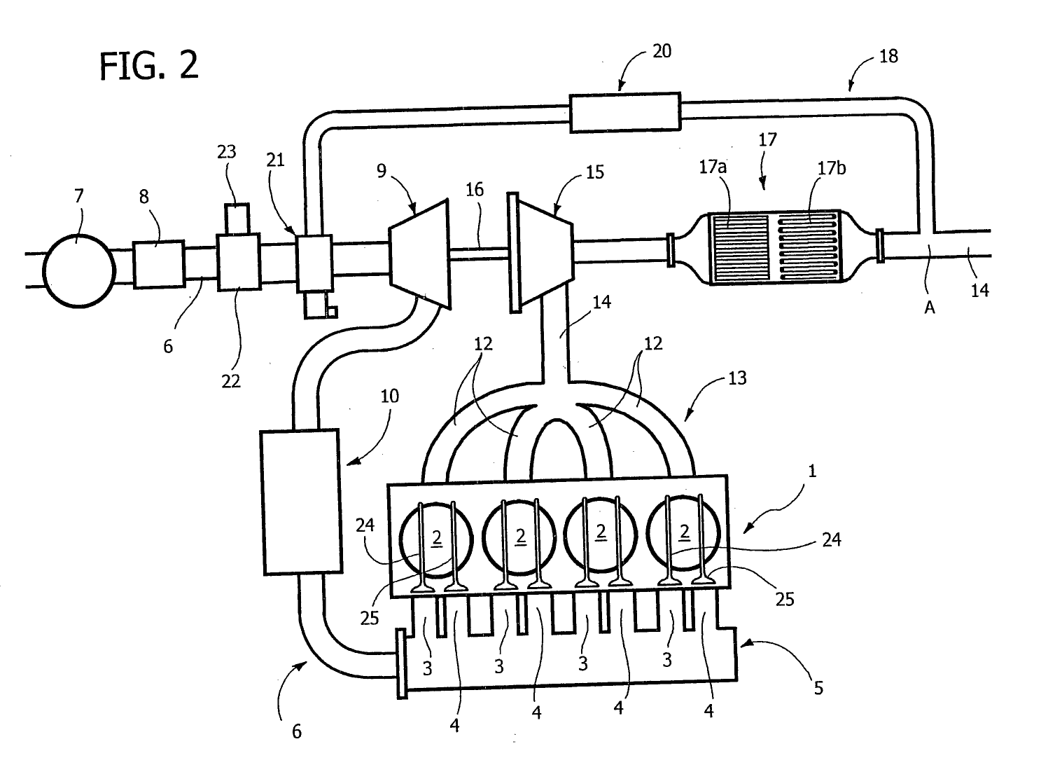

In FIG. 2, the parts that are in common with the ones of FIG. 1, already described above, are designated by the same reference numbers.

### DETAILED DESCRIPTION OF THE INVENTION

The main difference with respect to the conventional system illustrated in FIG. 1 lies in the fact that, in the case of the invention, the exhaust-gas recirculation pipe, designated by the reference number 18, branches off from the main exhaust pipe 14 starting from a point A located downstream of the gas-treatment device 17 and converges in the intake pipe 6 at a point located upstream of the compressor 9, where a valve 21 of any known type for control of the flow of the exhaust gases recirculated through the pipe 18 is located.

Of course, in conformance with the prior art, the actuator of the valve 21 is preferably controlled by electronic control means, according to a pre-set programmed logic. Also in the case of the invention, there is preferably provided an intercooler 20 set inside the exhaust-gas recirculation pipe 18. Furthermore, for the purpose of forcing passage of large amounts of exhaust gases, there is preferably provided a throttle valve 22, with a corresponding actuator device 23, which is capable of increasing the pressure jump through the recirculation pipe 18. Said device can be indifferently mounted on the intake pipe, as illustrated in FIG. 2, upstream of the point 21 of intake of recirculated gases, or else on the exhaust pipe 14, in a point downstream of the area A where the gas to be recirculated is drawn in.

Thanks to the arrangement described above, the advantages that have been extensively illustrated in the preceding description are achieved.

In a further preferred embodiment, the device according to the invention, in addition to the recirculation pipe 18 illustrated in FIG. 2, which provides a long-route EGR, may also be provided with a recirculation pipe 18 of the type illustrated in FIG. 1, according to a short-route arrangement. In this way, the advantages of the two systems are combined, thus obviating the partial drawbacks of the long-route system.

In a variant, in combination with the long-route EGR system illustrated in FIG. 2, the engine is also provided with an internal EGR system according to the teachings of the European patent application EP 1 273 770 A2 in the name of the present applicant. In this case, the engine is provided with means of the type illustrated in said known document. In particular, at least the intake valves 24, or else both the intake valves 24 and the exhaust valves 25 of the engine (FIG. 2), are controlled by the respective cams of the engine camshaft via a hydraulic electronic-control system of the type illustrated in the prior document in the name of the present applicant. Programming is such that, in given phases of the operating cycle of the engine, the intake and exhaust valves are maintained simultaneously open, in order that, during the exhaust stroke in a cylinder of the engine, part of the exhaust gases will return into the intake pipe and, in the subsequent induction stroke, the amount of exhaust gases previously fed into the intake pipe will return into the combustion chamber, together with a further part of the exhaust gases, which returns into the combustion chamber coming from the exhaust pipe, which is also left temporarily open during the induction stroke. Consequently, the total sum of the aforesaid two amounts of exhaust gases that will return into the combustion chamber is again subjected to a combustion stroke, so providing an EGR internal to the engine. Also the arrangement of said internal EGR in combination with the long-route recirculation system according to the invention enables maximization of the advantages of said solution, without presenting the drawbacks thereof.

Of course, without prejudice to the principle of the invention, the details of construction and the embodiments may vary widely with respect to what is described and illustrated herein purely by way of example, without thereby departing from the scope of the present invention.

1. A turbo-charged diesel engine, comprising:
at least one cylinder with at least one intake valve and at least one exhaust valve, which control, respectively, an intake pipe and an exhaust pipe;
a compressor set inside a main air-intake pipe connected to the aforesaid intake pipe of the cylinder;
a control turbine for driving the compressor, set inside a main exhaust pipe connected to said exhaust pipe of the cylinder;
an exhaust-gas treatment device, which is set inside the main exhaust pipe downstream of the turbine and comprises catalytic-converter means and particulate-filtering means; and
an exhaust-gas recirculation pipe, controlled by a respective exhaust-gas recirculation valve, for feeding at least part of the exhaust gases that flow in the main exhaust pipe back into the main pipe;
said engine being wherein said exhaust-gas recirculation pipe branches off from the main exhaust pipe at a point downstream of the turbine and of the exhaust-gas treatment device, and converges in the main intake pipe at a point upstream of the compressor.

2. The engine according to claim 1, wherein set in the exhaust-gas recirculation pipe is an intercooler.

3. The engine according to claim 1, wherein the exhaust-gas recirculation valve is set at the confluence of the exhaust-gas recirculation pipe in the main intake pipe.

4. The engine according to claim 1, wherein set inside the main intake pipe is a throttle valve, upstream of the confluence of the exhaust-gas recirculation pipe.

5. The engine according to claim 1, wherein set inside the main exhaust pipe, downstream of the branching of the exhaust-gas recirculation pipe, is a throttle valve.

6. The engine according to claim 1, wherein at least the intake valve of the cylinder is controlled by an electronic-control variable-actuation system, provided for enabling phases of simultaneous opening of the intake valve and of the exhaust valve in order to provide an exhaust-gas recirculation inside the engine.

7. The engine according to claim 1, wherein it comprises a further exhaust-gas recirculation pipe, which branches off from the main exhaust pipe upstream of the turbine and converges in the main intake pipe, downstream of the compressor.
